(19) United States
(12) Patent Application Publication
(10) Pub. No.: US 2004/0210532 A1
(43) Pub. Date: Oct. 21, 2004

(54) Access control apparatus

(76) Inventors: Tomoyoshi Nagawa, Kyoto (JP); Tsuyoshi Kindo, Sennan-gun (JP); Akihiro Suzuki, Itami (JP); Yorihiko Wakayama, Ibaraki (JP)

Correspondence Address: WENDEROTH, LIND & PONACK, L.L.P., 2033 K STREET N. W., SUITE 800, WASHINGTON, DC, 20006-1021, US

(21) Appl. No.: 10/820,973

(22) Filed: Apr. 9, 2004

(30) Foreign Application Priority Data
Apr. 16, 2003 (JP) 2003-112099

(51) Int. Cl. H04K 1/00

(52) U.S. Cl. 705/51

(57) ABSTRACT

To provide an access control apparatus which customizes a database of URIs, to which access restriction is applied, in accordance with an intended purpose of a user. A control section 201 obtains hypertext data from a Website corresponding to a URI received from a terminal. If access to a Website linked to the obtained hypertext data is restricted, the control section 201 obtains hypertext data and image data from the link destination Website. An unoffending image generating section 202 converts the image data for generating unoffending image data. The control section 201 rewrites a description of the hypertext data so that a link is established with restriction hypertext data, and transmits the rewritten data to the terminal. If the terminal requests a link with the restriction hypertext data, the control section 201 transmits the restriction hypertext data and the unoffending image data to the terminal.

### BACKGROUND OF THE INVENTION

1. Field of the Invention

The present invention relates to apparatuses for accessing a Website via the Internet. More particularly, the present invention relates to an apparatus for restricting access to a Website.

2. Description of the Background Art

A user can browse various Websites on the Internet using a communication terminal such as a PC. However, some Websites are not suitable for children or people working in the office. Thus, various types of access control apparatuses are proposed for restricting access to some Websites.

In a system disclosed in Japanese Patent Gazette No. 2980030, an access control apparatus is a server for extracting texts included in data written as HTML (Hypertext Mark-up Language) for displaying a desired Web page, and determining whether or not any of the extracted texts coincides with a keyword previously set as “inappropriate” before displaying the texts with the WWW (World Wide Web) browser. If any of the extracted texts coincides with the keyword, the access control apparatus transmits an error to the terminal, and prohibits the terminal from displaying the Web page. As a result, a page containing a keyword set as “inappropriate” to children is not displayed.

Also, for example, Japanese Patent Laid-Open Publication No. 2002-14991 (paragraphs [0002] and [0003]) discloses an access control apparatus which utilizes a database in which a URI (Universe Resource Identifier) of a Web page determined to contain inappropriate information is listed for disabling access to a Web page registered in the database.

However, the access control apparatus disclosed in Japanese Patent Gazette No. 2980030 only restricts access to text data, whereby it is impossible to restrict access to image data. For example, in the case where an inappropriate image is attached to the Web page, the above-described access control apparatus cannot effectively restrict access to the Web page.

On the other hand, the access control apparatus disclosed in Japanese Patent Laid-Open Publication No. 2002-14991 using the database of inappropriate URIs for performing access restriction restricts access to the Web page itself, whereby it is possible to prevent an inappropriate image from being displayed. However, due to the standardized data base used therefor, the above-described access control apparatus merely performs uniform access restriction. As a result, by the above-described access control apparatus, it is impossible to perform access restriction in accordance with the intended purpose of the user, even if the database contains a URI of a Web page to which the user needs to access for business purposes.

### SUMMARY OF THE INVENTION

Therefore, an object of the present invention is to provide an access control apparatus which customizes a database of URIs, to which access restriction is to be applied, in accordance with an intended purpose of a user.

The present invention has the following features to attain the object mentioned above.

The present invention is directed to an access control apparatus for restricting access from at least one terminal on a network to a Website on the Internet. The access control apparatus includes: source data obtaining means for obtaining source data necessary for displaying a Web page by accessing a Website corresponding to a URI when the URI is received from the terminal; access restriction determination means for determining whether or not access to a Website corresponding to a link destination URI linked to the source data obtained by the source data obtaining means is restricted; restriction source data obtaining/storing means for obtaining source data necessary for displaying a Web page from an access-restricted Website, and storing the obtained source data as restriction source data if determination is made by the access restriction determination means that access to the Website corresponding to the link destination URI is restricted; image data obtaining means for obtaining image data designated in the restriction source data obtained by the restriction source data obtaining/storing means; unoffending image generating means for generating unoffending image data by converting the image data obtained by the image data obtaining means; rewritten source data generating/transmitting means for generating rewritten source data by rewriting the source data of the Website, for which determination is made by the access restriction determination means that access thereto is restricted, so as to obtain the restriction source data, and transmitting the rewritten source data to the terminal; and unoffending image transmitting means for transmitting the restriction source data and the unoffending image data to the terminal if a link to the restriction source data is requested by the terminal.

As a result, it is possible to display unoffending image data used for allowing the user to roughly grasp the content of the Web page of the access-restricted Website, whereby the user can determine whether or not the Website is an inappropriate site to which access restriction should be applied. Also, the determination results can be utilized for customizing the database in which an access-restricted URI is registered.

Preferably, the rewritten source data generating/transmitting means may generate rewritten source data describing access restriction to the Website for which determination is made by the access restriction determination means that access thereto is restricted.

As a result, if a potentially inappropriate Website is linked with the Web page to be viewed by the user, a message saying “this site is potentially inappropriate” is displayed on the Web page. Thus, it is possible to notify the user of potential inappropriateness of the Website corresponding to the link destination URI.

Also, the rewritten source data generating/transmitting means may generate rewritten source data describing a link destination URI corresponding to the Website for which determination is made by the access restriction determination means that access thereto is restricted.

As a result, if a potentially inappropriate Website is linked with the Web page to be viewed by the user, a link destination URI corresponding to the potentially inappropriate Website is displayed on the Web page. Thus, the user can determine whether or not the link destination URI is potentially inappropriate.

Preferably, prohibition determination means for determining whether or not access to the Website corresponding to the link destination URI is prohibited if determination is made by the access restriction determination means that access thereto is restricted is further included. When determination is made by the prohibition determination means that access to the Website corresponding to the link destination URI is prohibited, the rewritten source data generating/transmitting means may generate rewritten source data by rewriting a description of the source data to disable a link to the Website.

As a result, if a tentative inappropriate Website is linked with the Web page to be viewed by the user, it is possible to prohibit the user from viewing the inappropriate link destination Web page.

In this case, the rewritten source data generating/transmitting means may generate rewritten source data describing prohibition of access to the Website for which determination is made by the prohibition determination means that access thereto is prohibited.

As a result, a message saying “this site is inappropriate” is displayed on the Web page, whereby it is possible to notify the user that the Website corresponding to the link destination URI is an inappropriate Website.

Preferably, the URI of the restricted Website is registered in a database. Also, the apparatus preferably further includes: notification instruction describing means for describing an instruction, in the restriction source data, for causing the terminal to transmit an agreement determination notification indicating to what degree a user is able to agree with the determination that access is restricted; agreement result registration means for registering a content of the agreement determination notification, which is received from the terminal, as being associated with the URI of the restricted Website; and URI deleting means for deleting, from the database, a URI whose registration content registered by the agreement result registration means meets a predetermined condition.

As a result, a URI of the Website determined by the user as appropriate is deleted from the database, whereby it is possible to automatically customize the database.

Preferably, the predetermined condition may be that agreement determination is performed more than a predetermined number of times, and a number of points added by users disagreeing with the determination may be greater than a number of points added by users agreeing with the determination.

As a result, if the number of points added by the users disagreeing with the determination is greater than the number of points added by the users agreeing with the determination, a URI of the Website is automatically deleted from the database.

Also, the predetermine number of times may be set for each URI.

For example, a smaller predetermined number is set for a highly inappropriate URI, and a greater predetermined number is set for a URI whose inappropriateness is difficult to be determined. As a result, it is possible to promptly determine whether or not a site is inappropriate, or leave the determination to a majority vote of the users.

Also, initial values may be previously set as the number of points added by users disagreeing with the determination and/or the number of points added by users agreeing with the determination.

As a result, it is possible to promptly determine whether or not a site is appropriate by setting initial values for an undeniably appropriate Website.

Also, the agreement result registration means may assign a weight to each user to change a number of points of agreement determination depending on the user.

As a result, it is possible to provide a highly-reliable customized database by assigning a weight to a user corresponding to his/her soundness of judgment.

Preferably, the URI of the restricted Website is registered in a database. The apparatus preferably further includes notification instruction describing means for describing an instruction, in the restriction source data, for causing the terminal to transmit an agreement determination notification indicating to what degree the user is able to agree with the determination that access is restricted; agreement result registration means for registering a content of the agreement determination notification, which is received from the terminal, as being associated with the URI of the restricted Website; and inappropriateness permanently-registration means for permanently registering a URI whose registration content registered by the agreement result registration means meets a predetermine condition in the database as a URI indicating an inappropriate Website.

As a result, a URI of the Website determined by the user as inappropriate is permanently registered in the database, whereby the database is automatically customized.

Preferably, the predetermined condition may be that agreement determination is performed more than a predetermined number of times, and a number of points added by users agreeing with the determination may be greater than a number of points added by users disagreeing with the determination.

As a result, if the number of points added by the users agreeing with the determination is greater than the number of points added by the users disagreeing with the determination, a URI of the Website is automatically registered in the database as a URI indicating an inappropriate site.

Also, the predetermined number may be set for each URI.

For example, a smaller predetermined number is set for a highly inappropriate URI, and a greater predetermined number is set for a URI whose inappropriateness is difficult to be determined. As a result, it is possible to promptly determine whether or not a site is inappropriate, or leave the determination to a majority vote of the users.

Also, initial values may be previously set as the number of points added by users disagreeing with the determination and/or the number of points added by users agreeing with the determination.

As a result, it is possible to promptly determine whether or not a site is inappropriate by setting initial values for an undeniably inappropriate Website.

Also, the agreement result registration means may assign a weight to each user to change a number of points of agreement determination depending on the user.

As a result, it is possible to provide a highly-reliable customized database by assigning a weight to a user corresponding to his/her soundness of judgment.

Preferably, the apparatus further includes: disagreement notification instruction describing means for describing an instruction, in the restriction source data, for causing the terminal to transmit a disagreement notification indicating that the user disagrees with the determination that access is restricted; and restriction cancel source data transmitting means for obtaining source data and image data necessary for displaying a Web page from the access-restricted Website, when the disagreement notification transmitted from the terminal is received, and transmitting the obtained data to the terminal.

As a result, it is possible to view a Web page determined by the user as appropriate.

Preferably, the apparatus further includes: notification URI regulation determination means for determining whether or not the Website corresponding to the URI received from the terminal is a tentative inappropriate Website; and tentative inappropriateness notification source data generating/transmitting means for generating tentative inappropriateness notification source data describing a link to the restriction source data if determination is made by the notification URI regulation determination means that the Website corresponding to the URI is a tentative inappropriate Website, and transmitting the generated data to the terminal.

As a result, it is possible to restrict the user from viewing a Web page of the potentially inappropriate Website.

In this case, the tentative inappropriateness notification source data generating/transmitting means may generate tentative inappropriateness notification source data describing access restriction to the Website determined as a tentative inappropriate Website by the notification URI regulation determination means.

As a result, a message saying “this site is potentially inappropriate” is displayed on the Web page, whereby it is possible to notify the user that he/she is going to view a potentially inappropriate Website.

Also, the tentative inappropriateness notification source data generating/transmitting means may generate tentative inappropriateness notification source data describing a link destination URI corresponding to the Website determined as a tentative inappropriate Website by the notification URI regulation determination means.

As a result, a potential inappropriate URI is displayed on the Web page, whereby the user can determine whether or not the URI is potentially inappropriate.

Preferably, the apparatus further includes: notification URI prohibition determination means for determining whether or not a Website corresponding to the URI received from the terminal is an inappropriate Website to which access prohibition is applied; and inappropriateness notification source data generating/transmitting means for generating inappropriateness notification source data describing access prohibition to the Website corresponding to the URI if determination is made by the notification URI prohibition determination means that the Website corresponding to the URI is an inappropriate Website, and transmitting the generated data to the terminal.

As a result, it is possible to prohibit the user from viewing a Web page of the inappropriate Website. Also, a message saying “this site is inappropriate” is displayed on the Web page, whereby it is possible to notify the user that he/she is going to view an inappropriate Website.

Preferably, the unoffending image generating means generates unoffending image data by converting the image data so that at least a portion thereof is hidden from view.

As a result, at least a portion of the image is hidden from view, whereby it is possible to convert an inappropriate image into an unoffending image.

Also, the unoffending image generating means may generate unoffending image data by changing a color of an image on the Web page.

As a result, a color of the image is changed, whereby it is possible to convert an inappropriate image into an unoffending image. Also, an outline, etc., of the original image is unchanged, whereby the user can roughly grasp the content of the Web page.

Also, the unoffending image generating means may generate unoffending image data by changing a size of an image on the Web page.

As a result, it is possible to convert an inappropriate image into an unoffending image by a size change. Also, the user can view what the original image shows, even if a size of the image is changed, whereby the user can grasp the content of the Web page.

Also, the unoffending image generating means may generate unoffending image data by changing an aspect ratio of an image on the Web page.

As a result, it is possible to convert an inappropriate image into an unoffending image by changing an aspect ratio of an image. Also, the user can view what the original image shows, even if an aspect ratio of the image is changed, whereby the user can grasp the content of the Web page.

Also, the unoffending image generating means may generate unoffending image data by dividing an image on the Web page into a plurality of parts, and arranging the divided parts at random.

As a result, it is possible to convert an inappropriate image into an unoffending image by arranging the divided parts of the original image at random. Also, the user can view what the original image shows, even if the divided parts of the original image are arranged at random, whereby the user can grasp the content of the Web page.

Also, the unoffending image generating means may generate unoffending image data by converting an image on the Web page as if it was attached to a curved surface.

As a result, it is possible to convert an inappropriate image into an unoffending image by converting the original image as if it was attached to a curved surface. Also, the user can view what the original image shows, even if the original image is converted as if it was attached to a curved surface, whereby the user can grasp the content of the Web page.

Also, the unoffending image generating means may generate unoffending image by attaching a filter image having a blacked-out portion to an image on the Web page.

As a result, it is possible to generate an unoffending image by hiding an inappropriate portion of the original image with a filter image. Also, the user can imagine the original image based on the unhidden portion, whereby the user can grasp the content of the Web page.

According to the present invention, the access control apparatus can display unoffending image data for allowing the user to roughly grasp the content of a Web page of an access-restricted Website, whereby the user can determine whether or not the Website is an inappropriate site to which access restriction should be applied. The determination results can be utilized to customize the database, in which an access-restricted URI is registered, in accordance with an intended purpose of the user.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustration showing the entire system to which an access control apparatus 200 according to one embodiment of the present invention is applied;

FIG. 2 is an illustration showing an exemplary access management database;

FIG. 3A is an illustration showing an exemplary screen displayed on a terminal 100 executing a browser;

FIG. 3B is an illustration showing an exemplary screen displayed on the terminal 100 executing the browser;

FIG. 3C is an illustration showing an exemplary screen displayed on the terminal 100 executing the browser;

FIG. 3D is an illustration showing an exemplary screen displayed on the terminal 100 executing the browser;

FIG. 3E is an illustration showing an exemplary screen displayed on the terminal 100 executing the browser;

FIG. 4 is a block diagram showing a functional structure of the access control apparatus 200;

FIG. 5 is a block diagram showing a functional structure of the terminal 100;

FIG. 6A is a sequence diagram showing an outline of an operation of the terminal 100 and the access control apparatus 200 when a URI is transmitted from the terminal 100 to the access control apparatus 200;

FIG. 6B is a sequence diagram showing an outline of an operation of the terminal 100 and the access control apparatus 200 in the case where the URI transmitted from the terminal 100 to the access control apparatus 200 is a temporarily inappropriate URI;

FIG. 6C is a sequence diagram showing an outline of an operation of the terminal 100 and the access control apparatus 200 in the case where the URI transmitted from the terminal 100 to the access control apparatus 200 is an agreement notification;

FIG. 6D is a sequence diagram showing an outline of an operation of the terminal 100 and the access control apparatus 200 in the case where the URI transmitted from the terminal 100 to the access control apparatus 200 is a disagreement notification;

FIG. 7 is a flowchart showing an operation of the terminal 100 executing the browser;

FIG. 8 is a flowchart showing an operation of the access control apparatus 200;

FIG. 9 is a flowchart showing an operation of the access control apparatus 200 during a tentative inappropriateness notification hypertext data generation process (step S207);

FIG. 10 is a flowchart showing an operation of the access control apparatus 200 during a restriction hypertext data generation process (steps S301 and S504);

FIG. 11 is a flowchart showing an operation of the access control apparatus 200 during a rewriting process (step S212);

FIG. 12 is a flowchart showing an operation of the access control apparatus 200 during a registration change process (step S220);

FIG. 13A is an illustration showing an exemplary filter image;

FIG. 13B is an illustration showing an exemplary filter image;

FIG. 13C is an illustration showing an exemplary filter image;

FIG. 14A is an illustration showing an exemplary subwindow for displaying an unoffending image in the case where a user is allowed to decide a subtle degree of inappropriateness or appropriateness of a site;

FIG. 14B is an illustration showing an exemplary subwindow for displaying an unoffending image in the case where the user is allowed to decide a subtle degree of inappropriateness or appropriateness of a site; and

FIG. 14c is an illustration showing an exemplary subwindow for displaying an unoffending image in the case where the user is allowed to decide a subtle degree of inappropriateness or appropriateness of a site.

### DESCRIPTION OF THE PREFERRED EMBODIMENTS

FIG. 1 is an illustration showing the entire system to which an access control apparatus according to one embodiment of the present invention is applied. In FIG. 1, the system includes an access restriction system 1, the Internet 2, a plurality of inappropriate Websites 3, and a plurality of appropriate Websites 4. Note that, in FIG. 1, it is assumed that there are two inappropriate Websites 3 and two appropriate Websites 4. However, there may be one inappropriate Website 3 and one appropriate Website 4, or there may be three or more inappropriate Websites 3 and three or more appropriate Websites 4.

The access restriction system 1, which is provided, for example, in premises of a company, performs communications with the inappropriate Websites 3 and the appropriate Websites 4 via the Internet 2. The inappropriate Website 3 is a Website unrelated to business information, whereas the appropriate Website 4 is a Website necessary for obtaining business information.

The access restriction system 1 includes a plurality of terminals 100, an access control apparatus 200, a storing apparatus 300, and a LAN 400. Note that, in FIG. 1, it is assumed that the number of terminals 100 is four, but it is not limited thereto. There may be three or less terminals 100, or there may be five or more terminals 100.

The terminal 100 is a communication terminal such as a PC for displaying a desired Web page by starting a browser. The access control apparatus 200 is connected to the Internet 2, thereby communicating with the inappropriate Websites 3 and the appropriate Websites 4. The access control apparatus 200 is a computer device such as a server for controlling access to the Internet 2 from the terminal 100. The terminal 100 and the access control apparatus 200 are connected via the LAN 400, thereby communicating with each other. The storing apparatus 300 stores an access management database registering a URI of a Web page to which access restriction is to be applied.

In order to display a Web page, the terminal 100 transmits a URI necessary for displaying the Web page to the access control apparatus 200. Also, if necessary, the terminal 100 transmits a notification specified in a hypertext data, which is Web page source data, to the access control apparatus 200. Hereinafter, when there is no need for differentiating the URI transmitted from the terminal 100 to the access control apparatus 200 and the notification specified in the hypertext data, they are collectively referred to as a request.

The access control apparatus 200 refers to the access management database stored in the storing apparatus 300, and determines whether or not a restriction is placed on the URI transmitted from the terminal 100.

When a URI on which no restriction is placed is received, the access control apparatus 200 accesses the received URI to obtain the hypertext data and data such as image (hereinafter, referred to as accompanying data) specified in the hypertext data. Then, the access control apparatus 200 refers to the access management database to determine whether or not a restriction is placed on the URI linked in the obtained hypertext data. Hereinafter, in order to differentiate between a URI received by the access control apparatus 200 from the terminal 100 and a URI extracted by the access control apparatus 200 from the obtained hypertext data, the latter is referred to as a link destination URI.

The access control apparatus 200 obtains hypertext data and accompanying data from a potentially inappropriate link destination URI. Then, the access control apparatus 200 generates unoffending image data (hereinafter, referred to as unoffending image data) by which a user can roughly grasp the content of the potentially inappropriate Web page, based on image data included in the accompanying data and specified in the hypertext data. The access control apparatus 200 also adds a description for transmitting a predetermined notification from the terminal 100 to the hypertext data obtained from the potentially inappropriate link destination URI, in order to ask the user whether to agree that the Website is inappropriate. In order to distinguish between the original hypertext data of the potentially inappropriate Web page and the hypertext data generated by the access control apparatus 200 by adding the above description to the original hypertext data, the latter is hereinafter referred to as restriction hypertext data. The restriction hypertext data and the unoffending image data are stored in a storing section of the access control apparatus 200.

Then, the access control section 200 rewrites a description portion about the link destination URI, on which a restriction is placed, in the hypertext data obtained from the unrestricted URI so as to become a description “inappropriate” or “potentially inappropriate”. Hereinafter, the hypertext data in which the description about the link destination URI is rewritten by the access control apparatus 200 based on the hypertext data obtained from the unrestricted URI is referred to as rewritten hypertext data. The access control apparatus 200 transmits the rewritten hypertext data to the terminal 100.

The terminal 100 analyzes the transmitted rewritten hypertext data, and displays the Web page. In this Web page, a message saying “this site is inappropriate” or “this site is potentially inappropriate” appears in a display portion of the link destination URI on which a restriction is placed. After the rewritten hypertext data is received, in accordance with an instruction from the user, the terminal 100 requests the access control apparatus 200 to transmit restriction hypertext data and unoffending image data. In response to the above request, the access control apparatus 200 transmits the restriction hypertext data and the unoffending image data to the terminal 100.

The terminal 100 analyzes the transmitted restriction hypertext data, and displays an unoffending image on the Web page. If the user agrees that the displayed Web page is inappropriate, the terminal 100 transmits a notification of the user's agreement to the access control apparatus 200. In response to the above notification, the access control apparatus 200 updates the attributes associated with the URI of the Website in the access management database.

On the other hand, if the user determines that the displayed Web page is appropriate, the terminal 100 transmits a notification of the user's disagreement to the access control apparatus 200. In response to the above notification, the access control apparatus 200 updates the attributes associated with the URI of the Website in the access management database. Then, the access control apparatus 200 downloads the hypertext data and the accompanying data necessary for displaying the Web page, and transmits these data to the terminal 100. The terminal 100 displays the Web page based on the transmitted data.

Also, when the restricted URI is received, the access control apparatus 200 generates hypertext data for notifying the user that the site is inappropriate, or the site is potentially inappropriate, and transmits the hypertext data to the terminal 100. Here, the hypertext data having a description “inappropriate” is referred to as inappropriateness notification hypertext data, and the hypertext data having a description “potentially inappropriate” is referred to as tentative inappropriateness notification hypertext data. If the inappropriateness notification hypertext data is received, the terminal 100 displays a message saying “this site is inappropriate”. On the other hand, if the tentative inappropriateness notification hypertext data is received, the terminal 100 displays a message saying “this site is potentially inappropriate”.

Also, the access control apparatus 200 obtains hypertext data and accompanying data from the potentially inappropriate URI, and generates restriction hypertext data and unoffending image data in the manner as described above.

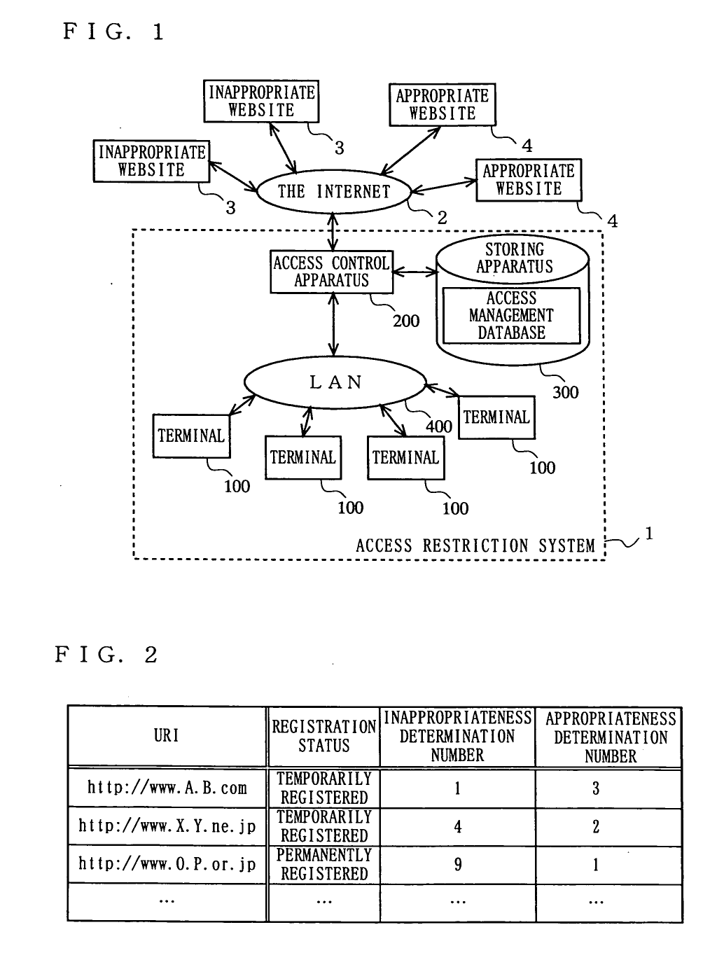

FIG. 2 is an illustration showing an exemplary access management database. The access management database is a collection of URIs of inappropriate sites. Each URI is provided with a registration status, an inappropriateness determination number, and an appropriateness determination number as attributes associated therewith.

The registration status is either a permanent registration or a temporal registration. The access restriction system 1 prohibits access to a Website of a permanently registered URI. On the other hand, the access restriction system 1 does not prohibit access to a Website of a temporarily registered URI. In this case, the terminal 100 displays the content of the Website of the temporarily registered URI with a message saying “this site is potentially inappropriate”. The URI of an undeniably inappropriate site is permanently registered. On the other hand, a URI of a potentially inappropriate site is temporarily registered at first.

The inappropriateness determination number is the number of users who agree that a Website of a URI is inappropriate, and the appropriateness determination number is the number of users who agree that a Website of a URI is appropriate.

When the sum of the inappropriateness determination number and appropriateness determination number exceeds a predetermined number, the access control apparatus 200 checks the current setting of the registration status. If the inappropriateness determination number exceeds the appropriateness determination number, the access control apparatus 200 changes the registration status of the corresponding URI so that the URI is permanently registered. Hereinafter, the access control apparatus 200 prohibits access to the Website of this URI. On the other hand, if the inappropriateness determination number is no more than the appropriateness determination number, the access control apparatus 200 decides that the Website of the corresponding URI is appropriate, and deletes this URI from the access management database.

The URIs on the Internet can be classified into three categories. A first category includes a URI of an appropriate Website. Such a URI is referred to as an appropriate URI. A second category includes a URI temporarily registered in the access management database. A Website of a temporarily registered URI is potentially inappropriate. Such a URI is referred to as a tentative inappropriate URI. A third category includes a URI permanently registered in the access management database. A Website of a permanently registered URI is considered undeniably inappropriate. Such a URI is referred to as an inappropriate URI.

Also, in the hypertext data, there are two types of link destination designation patterns. With a first designation pattern, the URI merely designates a link destination. Such a pattern is referred to as a link destination designation type. With a second designation pattern, the URI designates a link destination and gives an instruction to display a predetermined image on the link source Web page. Such a pattern is referred to as an embedded type.

Thus, in the access restriction system 1, the link destination URIs are classified into the following six categories: an appropriate URI of a link destination designation type; an appropriate URI of an embedded type; a tentative inappropriate URI of a link destination designation type; a tentative inappropriate URI of an embedded type; an inappropriate URI of a link destination designation type; and an inappropriate URI of an embedded type.

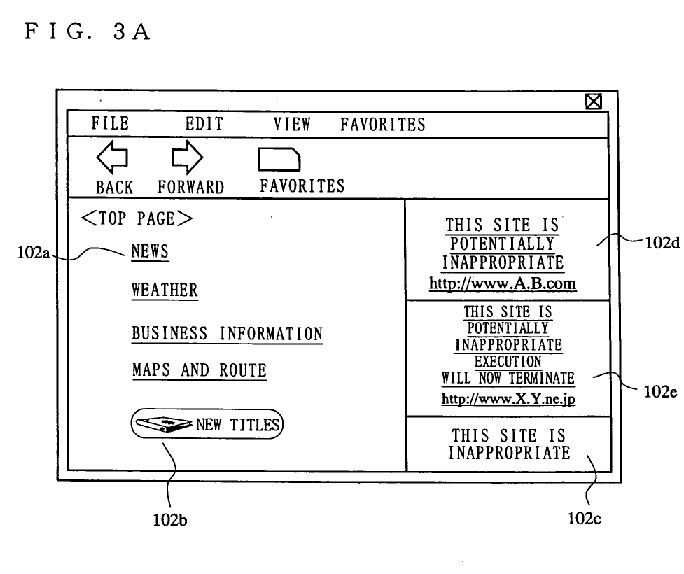

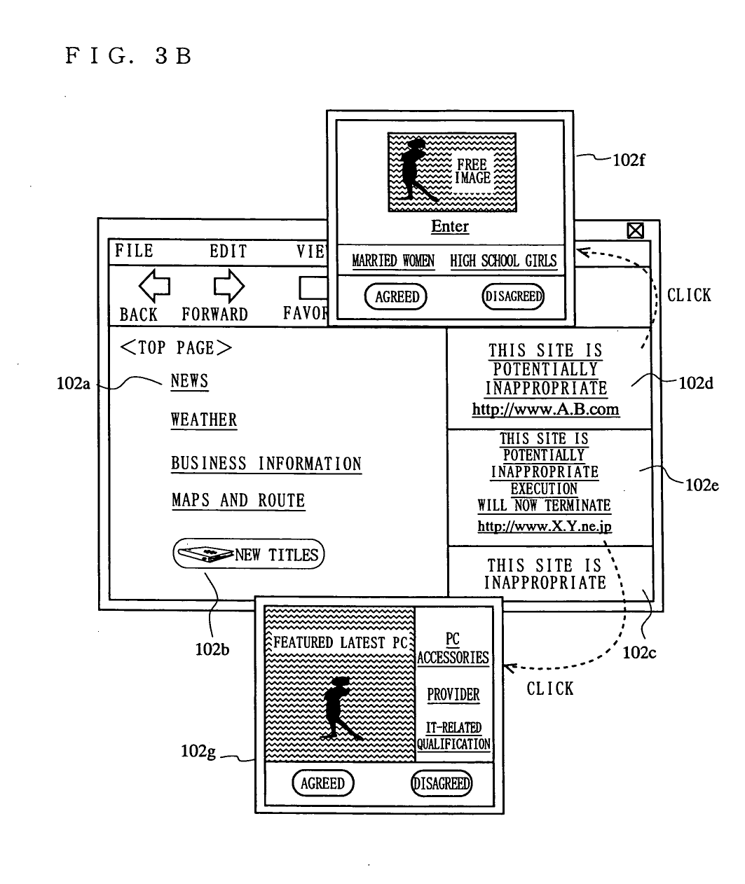

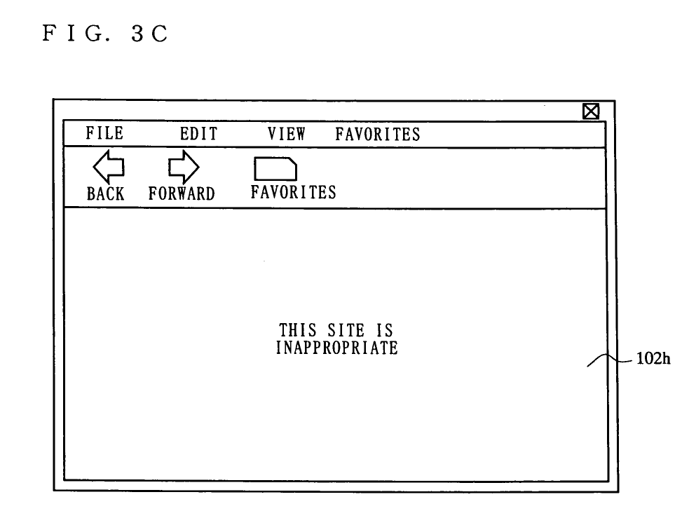

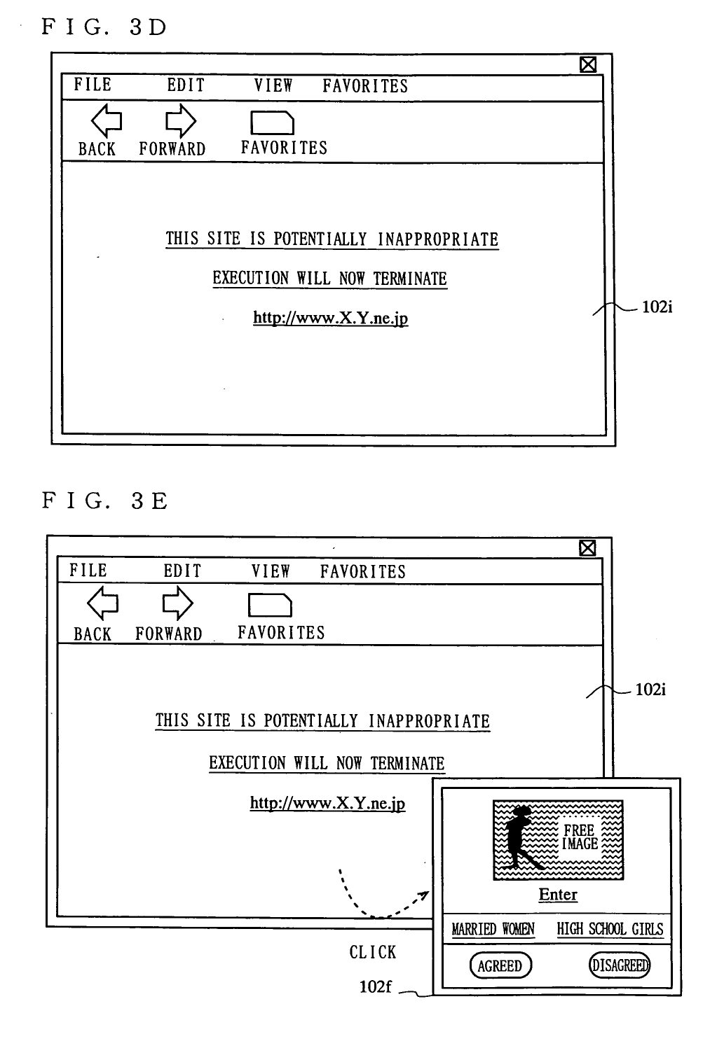

FIG. 3A is an illustration showing an exemplary screen displayed on the terminal 100 in the case where the terminal 100 notifies an appropriate URI. When the appropriate URI is received, the access control apparatus 200 obtains hypertext data and accompanying data from the appropriate URI. Then, the access control apparatus 200 extracts a link destination URI from the obtained hypertext data, and determines whether the extracted link destination URI is an appropriate URI, a tentative inappropriate URI, or an inappropriate URI.

In the case where the extracted link destination URI is an appropriate URI of a link destination designation type, the access control apparatus 200 does not rewrite a portion of the obtained hypertext data describing the link destination URI. The terminal 100 displays a text representing a link destination, whereby the user can jump to the link destination. In this case, the terminal 100 displays, for example, a portion 102a of FIG. 3A.

In the case where the extracted link destination URI is an appropriate URI of an embedded type, the access control apparatus 200 does not rewrite a portion of the obtained hypertext data describing the link destination URI. The terminal 100 displays an image representing a link destination, whereby the user can jump to the link destination. In this case, the terminal 100 displays, for example, a portion 102b of FIG. 3A.

In the case where the extracted link destination URI is an inappropriate URI of a link destination designation type or an embedded type, the access control apparatus 200 deletes a description about the link destination URI, which is an inappropriate URI, from the obtained hypertext data, and describes a message saying “this site is inappropriate” (hereinafter, referred to as a warning message regarding an inappropriate Website). The terminal 100 does not display a link destination of the inappropriate URI, whereby the user cannot jump to the link destination. In this case, the terminal 100 displays, for example, a portion 102c of FIG. 3A.

In the case where the extracted link destination is a tentative inappropriate URI of a link destination designation type, the access control apparatus 200 obtains hypertext data and accompanying data from the tentative inappropriate URI, and generates restriction hypertext data and unoffending image data. Then, the access control apparatus 200 rewrites a portion, in which the link destination URI is described, of the hypertext data obtained from the above-described appropriate URI so that a message saying “this site is potentially inappropriate” and the tentative inappropriate URI (hereinafter, collectively referred to as a warning message regarding a tentative inappropriate Website) are displayed. The warning message regarding a tentative inappropriate Website includes a URI showing where the restriction hypertext data is stored. The terminal 100 displays a warning message regarding a tentative inappropriate Website. In this case, the terminal 100 displays, for example, a portion 102d of FIG. 3A.

In the case where the extracted link destination URI is a tentative inappropriate URI of an embedded type, the access control apparatus 200 generates restriction hypertext data and unoffending image data, as is the case with the tentative inappropriate URI of a link destination designation type. The access control apparatus 200 deletes, from the obtained hypertext data, a download destination URI of image data used for displaying an embedded link. Then, the access control apparatus 200 rewrites a portion, in which the link destination URI is described, of the hypertext data obtained from the appropriate URI so that messages saying “this site is potentially inappropriate” and “execution will now terminate” (hereinafter, collectively referred to as a termination message) are displayed. The termination message includes a URI showing where the restriction hypertext data is stored. The terminal 100 displays a termination message, and does not display the embedded link. In this case, the terminal 100 displays, for example, a portion 102e of FIG. 3A.

FIG. 3B is an illustration showing an exemplary screen displayed on the terminal 100 in the case where a portion displaying a warning message regarding a tentative inappropriate Website or a termination message is clicked in FIG. 3A. As mentioned above, when the user clicks a display portion as shown in 102d or 102e, the access control apparatus 200 transmits the restriction hypertext data and the unoffending image data to the terminal 100. In this case, the terminal 100 displays, for example, a portion as shown in 102f or 102g.

If the user agrees that the site is potentially inappropriate after viewing the unoffending image displayed on the Web page with the browser, he/she clicks an “agreement” button. When the “agreement” button is clicked, a predetermined notification (hereinafter, referred to as an agreement notification) is transmitted from the terminal 100 to the access control apparatus 200. When the agreement notification is received, the access control apparatus 200 increments the inappropriateness determination number of the tentative inappropriate URI included in the agreement notification by 1. For example, in the case where an unoffending image as shown in a portion 102f of FIG. 3B is displayed, it is anticipated that the user agrees that this site is inappropriate because the site shows a human figure and a “free image” message on the right side thereof.

On the other hand, if the user disagrees that the site is potentially inappropriate after viewing the unoffending image displayed on the Web page with the browser, he/she clicks a “disagreement” button. When the “disagreement” button is clicked, a predetermined notification (hereinafter, referred to as a disagreement notification) is transmitted from the terminal 100 to the access control apparatus 200. When the disagreement notification is received, the access control apparatus 200 increments the appropriateness determination number of the tentative inappropriate URI included in the disagreement notification by 1. For example, in the case where an unoffending image as shown in a portion 102g of FIG. 3B is displayed, it is anticipated that the user determines that this site is appropriate because the site shows a title of “Featured Latest PC” on the upper side of a human figure.

FIG. 3C is an illustration showing an exemplary screen displayed on the terminal 100 in the case where an inappropriate URI is notified by the terminal 100. When the inappropriate URI is notified by the terminal 100, the access control apparatus 200 generates inappropriateness notification hypertext data. The generated inappropriateness notification hypertext data is transmitted to the terminal 100. The terminal 100 does not display a link destination of the inappropriate URI, whereby the user cannot jump to the link destination. In this case, the terminal 100 displays, for example, a portion 102h of FIG. 3C.

FIG. 3D is an illustration showing an exemplary screen displayed on the terminal 100 in the case where a tentative inappropriate URI is notified by the terminal 100. The access control apparatus 200 generates tentative inappropriateness notification hypertext data in which a termination message is described. The access control apparatus 200 transmits the generated tentative inappropriateness notification hypertext data to the terminal 100. In this case, the terminal 100 displays, for example, a portion 102i of FIG. 3D.

FIG. 3E is an illustration showing an exemplary screen displayed on the terminal 100 in the case where a display portion of the termination message is clicked in FIG. 3D. If the user desires to check whether or not the site displayed in the portion 102i of FIG. 3E is really inappropriate, he/she clicks the display portion. In response to a click by the user, the URI is transmitted from the terminal 100 to the access control apparatus 200. The transmitted URI is a URI showing where the restriction hypertext data is stored. The access control apparatus 200 transmits, to the terminal 100, the restriction hypertext data and the unoffending image data stored in the storing section. The terminal 100 displays, in a subwindow, a Web page showing an unoffending image with the “agreement” button and the “disagreement” button displayed at the bottom thereof. In this case, the terminal 100 displays, for example, a portion 102f of FIG. 3E.

Here, the structure of the restriction hypertext data generated by the access control apparatus 200 will be described. When a tentative inappropriate URI is received from the terminal 100, or when a tentative inappropriate URI is being designated in the hypertext data, the access control apparatus 200 obtains hypertext data and accompanying data from the tentative inappropriate URI, and generates restriction hypertext data and unoffending image data. After the unoffending image data is generated, the access control apparatus 200 adds a description to the obtained hypertext data, thereby generating the restriction hypertext data.

Specifically, the access control apparatus 200 rewrites a description in the restriction hypertext data designating image data in order to designate unoffending image data. For example, in the original hypertext data obtained for generating restriction hypertext data, the image data is designated by a relative path or an absolute path. The access control apparatus 200 rewrites the relative path or the absolute path used for designating an address of the image data to a path of the generated unoffending image data. Note that, if the unoffending image data is stored in the same directory as the restriction hypertext data, the unoffending image data may be designated by only a file name in the restriction hypertext data. Hereinafter, in the present embodiment, assume that the unoffending image data is stored in the same directory as the restriction hypertext data. Therefore, in the present embodiment, assume that the unoffending image data in the restriction hypertext data is designated by only a file name.

Then, the access control apparatus 200 adds, to the obtained hypertext data, a description for displaying the “agreement” button and the “disagreement” button under the unoffending image. The access control apparatus 200 describes an instruction in the hypertext data for transmitting the agreement notification or the disagreement notification from the terminal 100 to the access control apparatus 200 when the user clicks the “agreement” button or the “disagreement” button. The agreement notification and the disagreement notification have the original tentative inappropriate URI included therein.

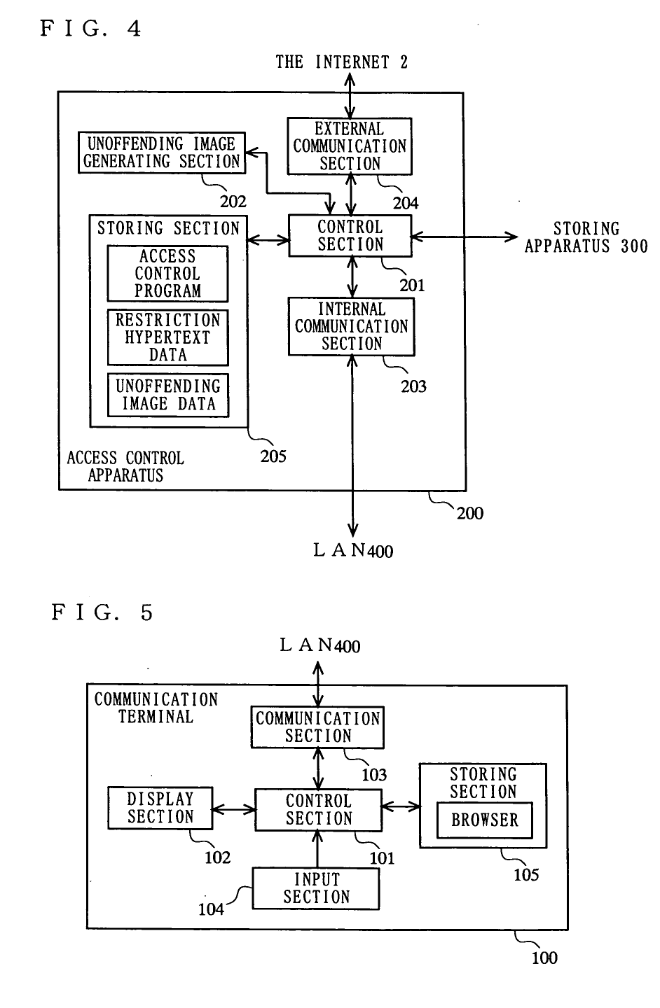

FIG. 4 is a block diagram showing a functional structure of the access control apparatus 200. In FIG. 4, the access control apparatus 200 includes a control section 201, an unoffending image generating section 202, an internal communication section 203, an external communication section 204, and a storing section 205.

The control section 201 controls the access control apparatus 200 to perform the following operations: obtaining data from the Web site and transmitting the obtained data to the terminal 100; determining whether to perform access control of a URI notified by the terminal 100; generating inappropriateness notification hypertext data; generating tentative inappropriateness notification hypertext data; generating rewritten hypertext data; instructing the unoffending image generating section 202 to generate unoffending image data; generating restriction hypertext data; and updating the access management database, or the like.

The storing section 205, which is a storing medium such as a hard disk, stores restriction hypertext data and unoffending image data.

An access control program is appropriately read and executed by the control section 201.

The unoffending image generating section 202 generates unoffending image data in response to an instruction from the control section 201. Then, the unoffending image generating section 202 sends the generated unoffending image data to the control section 201.

When the unoffending image data is received, the control section 201 generates restriction hypertext data. The restriction hypertext data and the unoffending image data are stored in the storing section 205.

The internal communication section 203 is a communication device for performing communications with the terminal 100 via the LAN 400.

The external communication section 204 is a communication device for performing communications with a Website via the Internet 2.

FIG. 5 is a block diagram showing a functional structure of the terminal 100. In FIG. 5, the terminal 100 includes a control section 101, a display section 102, a communication section 103, an input section 104, and a storing section 105.

The display section 102 is, for example, a display for displaying an image in accordance with an instruction from the control section 101.

The communication section 103 is a communication device for performing communications with the access control apparatus 200 via the LAN 400.

The input section 104 is, for example, a keyboard or a mouse for inputting a user operation.

The storing section 105 is a storing medium such as a hard disk for storing a browser, which is a program necessary for displaying a Web page. The browser, which is a commonly-used Web browser, reproduces texts, images, moving images, and audio, etc., in accordance with a description in the hypertext data.

The control section 101 reads the browser stored in the storing section 105 for storing the read browser in an internal memory (not shown), and causes the display section 102 to display a desired Web page by executing the stored browser. The control section 101 analyzes the hypertext data transmitted from the access control apparatus 200, and causes the display section 102 to display the Web page.

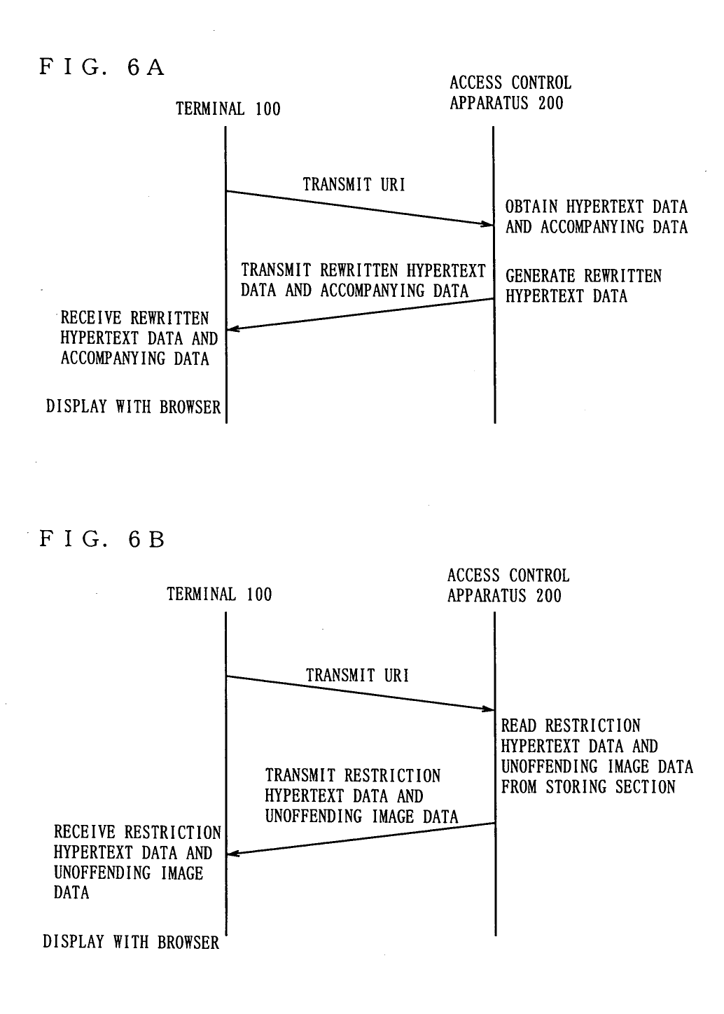

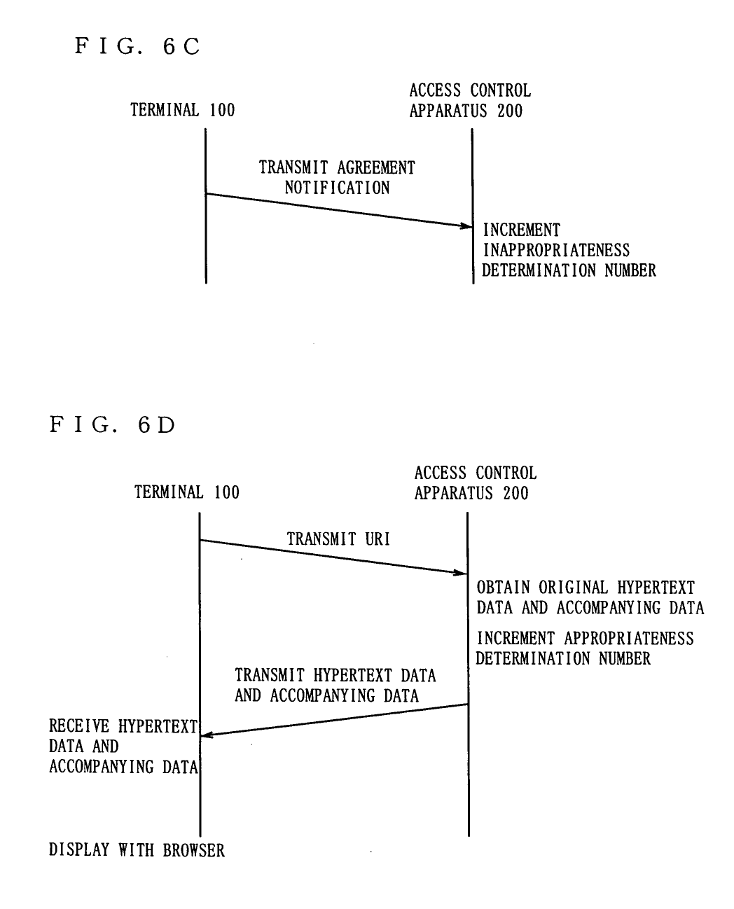

FIG. 6A is a sequence diagram showing an outline of an operation of the terminal 100 and the access control apparatus 200 when an appropriate URI is transmitted from the terminal 100 to the access control apparatus 200. Hereinafter, with reference to FIG. 6A, an outline of the operation performed by the terminal 100 and the access control apparatus 200 will be described.

When the appropriate URI is received, the access control apparatus 200 accesses the Website designated by the appropriate URI, and obtains hypertext data and accompanying data. Then, the access control apparatus 200 determines whether or not a link destination URI described in the obtained hypertext data is restricted. In the case where all link destination URIs described in the obtained hypertext data are appropriate URIs, the access control apparatus 200 transmits, to the terminal 100, the description of the hypertext data as it is. On the other hand, in the case where a restricted link destination URI is described in the obtained hypertext data, the access control apparatus rewrites a description of the hypertext data about the link destination URI. Hereinafter, irrespective of whether or not a description in the hypertext data is rewritten, hypertext data obtained as a result of determination by the access control apparatus 200 about whether or not a link destination URI is restricted is referred to as rewritten hypertext data. The rewritten hypertext data generated by the access control apparatus 200 and accompanying data are transmitted to the terminal 100. When the rewritten hypertext data is received, the terminal 100 causes the browser to display the Web page.

FIG. 6B is a sequence diagram showing an outline of an operation of the terminal 100 and the access control apparatus 200 when the user clicks a display portion of a tentative inappropriate URI on a screen on which a warning message regarding a tentative inappropriate Website is displayed. Hereinafter, with reference to FIG. 6B, an outline of the operation performed by the terminal 100 and the access control apparatus 200 will be described.

When the tentative inappropriate URI is received from the terminal 100, the access control apparatus 200 reads the restriction hypertext data and the unoffending image data from the storing section 205, and transmits the read data. When the transmitted restriction hypertext data is received, the terminal 100 causes the browser to display the Web page.

FIG. 6C is a sequence diagram showing an outline of an operation of the terminal 100 and the access control apparatus 200 when the user clicks an agreement button. Hereinafter, with reference to FIG. 6C, an outline of the operation performed by the terminal 100 and the access control apparatus 200 will be described.

When the agreement notification is received, the access control apparatus 200 refers to the access management database, and increments the inappropriateness determination number by 1.

FIG. 6D is a sequence diagram showing an outline of an operation of the terminal 100 and the access control apparatus 200 when the user clicks a disagreement button. Hereinafter, with reference to FIG. 6D, an outline of the operation performed by the terminal 100 and the access control apparatus 200 will be described.

When the disagreement notification is received, the access control apparatus 200 obtains original hypertext data and accompanying data from the tentative inappropriate URI included in the disagreement notification. The obtained hypertext data and the accompanying data are transmitted to the terminal 100 without being rewritten. When the transmitted hypertext data and the accompanying data are received, the terminal 100 causes the browser to display the Web page. Also, the access control apparatus 200 refers to the access management database, and increments the appropriateness determination number by 1.

Hereinafter, detailed operations of the terminal 100 and the access control apparatus 200 in the access restriction system 1 will be described.

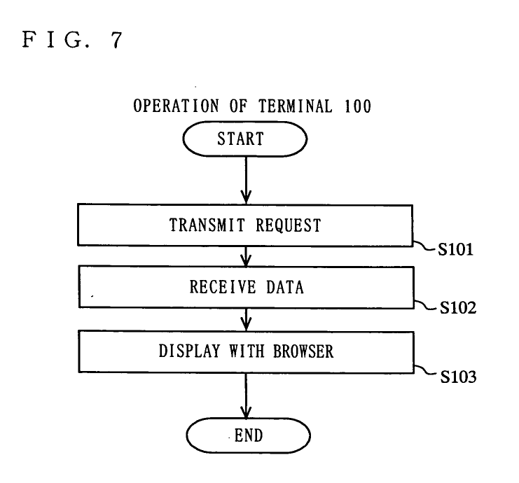

FIG. 7 is a flowchart showing an operation of the terminal 100 executing the browser. Hereinafter, with reference to FIG. 7, the operation of the terminal 100 executing the browser will be described. Hereinafter, unless otherwise specified, it is assumed that the terminal 100 is executing the browser.

First, the control section 101 of the terminal 100 transmits a request to the access control apparatus 200 (step S101). If the user issues an instruction to display a desired Web page, a URI is transmitted to the access control apparatus 200 as a request. If the user clicks an agreement button or a disagreement button displayed on the Web page, an agreement notification or a disagreement notification is transmitted to the access control apparatus 200 as a request.

Next, the control section 101 receives the hypertext data and the accompanying data transmitted from the access control apparatus 200 via the communication section 103 (step S102). The control section 101 reads the received hypertext data, and causes the display section 102 to display the Web page (step S103). If the accompanying data is unoffending image data, an unoffending image is displayed on the Web page displayed by the display section 102.

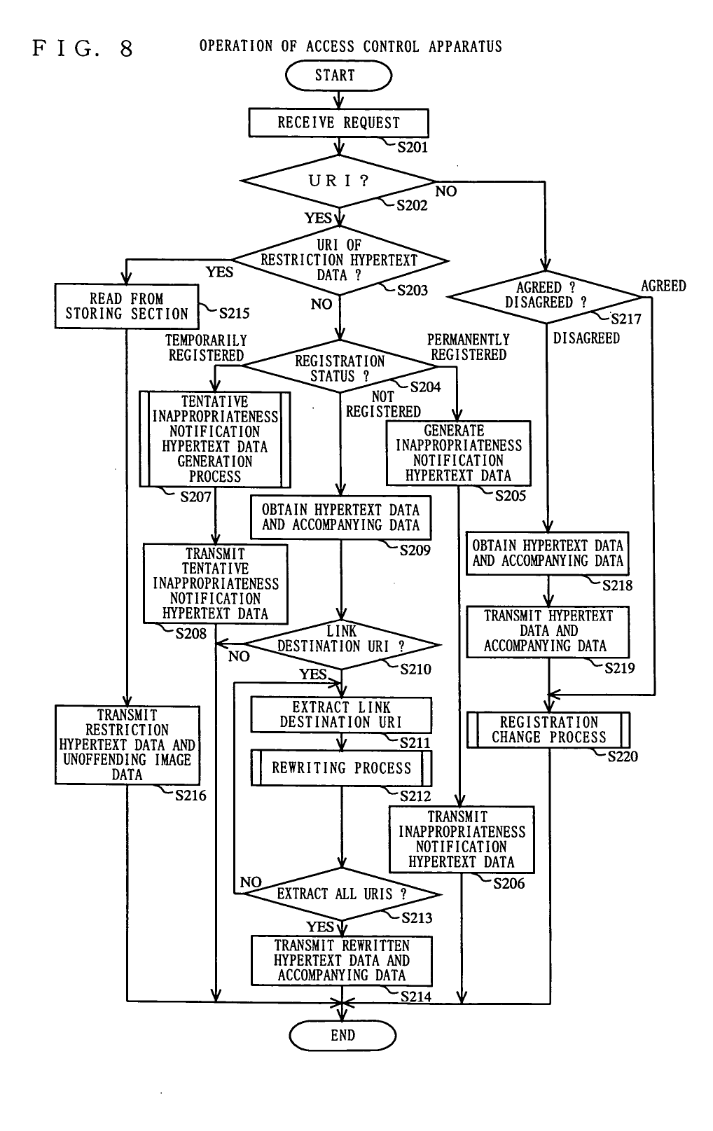

FIG. 8 is a flowchart showing an operation of the access control apparatus 200. Hereinafter, with reference to FIG. 8, the operation of the access control apparatus 200 will be described.

First, the control section 201 of the access control apparatus 200 receives a request transmitted from the terminal 100 via the internal communication section 203 (step S201). Next, the control section 201 determines whether or not the received request is a URI (step S202). If the received request is a URI, the control section 201 determines whether or not the URI designates restriction hypertext data (step S203).

If the URI does not designate restriction hypertext data, that is, if the URI does not designate a storing section, the control section 201 refers to the access management database stored in the storing apparatus 300 for checking a registration status of the URI (step S204). If the access management database contains a URI corresponding to the received URI, and the registration status of the received URI is a “permanent registration”, the control section 201 determines that the URI is an inappropriate URI.

In this case, the control section 201 does not obtain hypertext data and accompanying data from the inappropriate URI. The control section 201 generates inappropriateness notification hypertext data in which a warning message regarding an inappropriate Website is described (step S205). Then, the control section 201 transmits the generated inappropriateness notification hypertext data to the terminal 100 (step S206), and ends the process. In this case, the terminal 100 displays, for example, a portion 102h as shown in FIG. 3C.

On the other hand, if there is a URI corresponding to the received URI in the access management database, and the registration status is a temporal registration in step S204, the control section 201 determines that the URI is a tentative inappropriate URI. The control section 201 generates tentative inappropriateness notification hypertext data (step S207). A process performed in step S207 is referred to as a tentative inappropriateness notification hypertext data generation process. Then, the control section 201 transmits the tentative inappropriateness notification hypertext data generated in the tentative inappropriateness notification hypertext data generation process to the terminal 100 (step S208), and ends the process. In this case, the terminal 100 displays, for example, a portion 102i as shown in FIG. 3D.

Also, if there is no URI corresponding to the received URI in the access management database in step S204, the control section 201 determines that the received URI is an appropriate URI. Then, the control section 201 obtains hypertext data and accompanying data from the received URI (step S209).

The control section 201 refers to the obtained hypertext data, and determines whether or not the link destination URI is included therein (step S210). If the link destination URI is included therein, the control section 201 extracts one link destination URI from the hypertext data (step S211). Then, the control section 201 rewrites the extracted link destination URI (step S212). A process performed in step S212 is referred to as a rewriting process.

Next, the control section determines whether or not all link destination URIs included in the hypertext data are extracted (step S213). If there are some link destination URIs to be extracted left in the hypertext data, the control section 201 goes back to the process in step S211, and extracts the remaining link destination URIs from the hypertext data.

As such, the process from step S211 to step S213 is repeated until the rewriting process is performed for all link destination URIs included in the hypertext data. When the rewriting process is performed for all link destination URIs, the control section 201 transmits the rewritten hypertext data and the accompanying data to the terminal 100 via the internal communication section 203 (step S214), and ends the process.

On the other hand, determination is made in step S203 that the received URI is restriction hypertext data, the control section 201 reads restriction hypertext data and unoffending image data from the storing section (step S215), and transmits the read data to the terminal 100 (step S216). In this case, the terminal 100 displays, for example, a portion 102f as shown in FIGS. 3B and 3E, or a portion 102g as shown in FIG. 3B.

On the other hand, if determination is made in step S202 that the received request is not a URI, the request is either an agreement notification or a disagreement notification. The control section 201 determines whether the received request is an agreement notification or a disagreement notification (step S217). If the request is a disagreement notification, the control section 201 obtains hypertext data and accompanying data from the original tentative inappropriate URI included in the disagreement notification (step S218), and transmits the obtained data to the terminal 100 (step S219). Next, the control section 201 changes the registration status of the URI in the access management database (step S220). A process performed in step S220 is referred to as a registration change process.

On the other hand, if the received request is an agreement notification, the control section 201 starts a registration change process without obtaining hypertext data (step S220). After the registration change process is completed, the control section 201 ends the process.

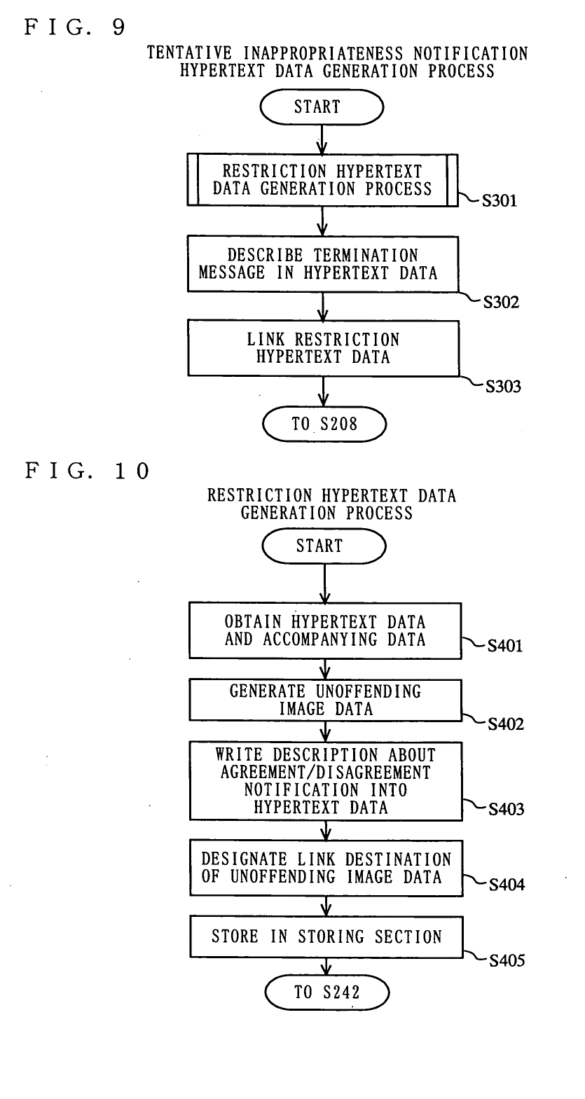

FIG. 9 is a flowchart showing an operation of the access control apparatus 200 during a tentative inappropriateness notification hypertext data generation process (step S207). Hereinafter, with reference to FIG. 9, the operation of the access control apparatus 200 in the case where the received URI is a tentative inappropriate URI will be described.

First, the control section 201 of the access control apparatus 200 generates restriction hypertext data (step S301). A process performed in step S301 is referred to as a restriction hypertext data generation process.

The control section 201 then generates tentative inappropriateness notification hypertext data. First, the control section 201 describes a termination message in the tentative inappropriateness notification hypertext data (step S302), and links a URI showing where the restriction hypertext data is stored with the termination message (step S303). Then, the control section 201 proceeds to step S208.

FIG. 10 is a flowchart showing an operation of the access control apparatus 200 during a restriction hypertext data generation process (step S301). Hereinafter, with reference to FIG. 10, the operation of the access control apparatus 200 during the restriction hypertext data generation process will be described.

First, the control section 201 of the access control apparatus 200 accesses a tentative inappropriate URI, and obtains hypertext data and accompanying data (step S401). The control section 201 sends image data included in the accompanying data and designated by the obtained hypertext data to the unoffending image generating section 202, and instructs the unoffending image generating section 202 to generate unoffending image data. The unoffending image generating section 202 generates unoffending image data (step S402), and sends the generated unoffending image data to the control section 201.

There are various methods for generating the unoffending image data. For example, in order to change the original image data into unoffending image data, the unoffending image generating section 202 may replace a color of the original image data with a complementary color, thereby using negative data of the original image as an unoffending image, or replace a color of the original image data with black and white. Alternatively, the unoffending image generating section 202 may perform posterization (reduction of color levels), or may change a color tone of the original image data. As such, the user can see the content of the original image because the resultant image, which is generated by color change of an original image to be displayed on the Web page, shows a character or an outline of an object, etc., in the original image, while having less of a chance of viewing an inappropriate image because the resultant image has a different color, etc., from the original image. Thus, the generated unoffending image helps the user to determine whether or not the original image is inappropriate.

Note that a change of color tone is realized by, for example, changing the order of values R, G, and B of original RGB data, such that RGB data (1100, 0011, 0011) is replaced with RGB data (0011, 1100, 0011).

When the unoffending image data is received, the control section 201 writes, in the obtained hypertext data, a description for displaying the “agreement” button and the “disagreement” button. Then, the control section 201 describes, in the obtained hypertext data, an instruction for causing the access control apparatus 200 to transmit the agreement notification or the disagreement notification when the user clicks the “agreement” button or the “disagreement” button (step S403). Next, the control section 201 rewrites a path of the image data designated in the obtained hypertext data to a file name of the unoffending image data (step S404). The control section 201 stores the restriction hypertext data and the unoffending image data in the storing section 205 (step S405). Then, the control section 201 proceeds to step S302.

FIG. 11 is a flowchart showing an operation of the access control apparatus 200 during a rewriting process (step S212). Hereinafter, with reference to FIG. 11, the operation of the access control apparatus 200 when a URI is extracted from the hypertext data will be described.

First, the control section 201 of the access control apparatus 200 refers to the access management database, and checks a registration status of the extracted link destination URI (step S501). A process performed in step S501 is the same as the process performed in step S202 of FIG. 8. If the link destination URI is an appropriate URI, the control section 201 ends the rewriting process. Then, the control section 201 proceeds to step S213.

On the other hand, if the registration status is a permanent registration, the control section 201 determines that the URI is an inappropriate URI, and deletes a link destination of the inappropriate URI from the hypertext data (step S502). Next, the control section 201 writes a warning message regarding an inappropriate Website in the hypertext data (step S503). Then, the control section 201 proceeds to step S213.

On the other hand, if determination is made in step S501 that the registration status is a temporal registration, the control section 201 determines that the URI is a tentative inappropriate URI, and starts a restriction hypertext data generation process (step S504). The restriction hypertext data generation process performed in step S504 is the same as the restriction hypertext data generation process performed in step S301 of FIG. 9.

After the restriction hypertext data is generated in step S504, the control section 201 refers to the hypertext data obtained in step S209, and determines whether or not the link destination designation pattern is an embedded type (step S505). If the designation pattern is an embedded type, the control section 201 deletes, from the hypertext data, a download destination URI of the image data associated with the embedded link (step S506), and writes a termination message (step S508). The control section 201 rewrites the hypertext data so that a display portion of the termination message has links with a URI showing where the restriction hypertext data is stored (step S509). Then, the control section 201 proceeds to step S213.

On the other hand, if determination is made in step S505 that it is not an embedded type, the designation pattern is a link destination designation type. The control section 201 writes a warning message regarding a tentative inappropriate Website in the hypertext data (step S508). Then, the control section 201 rewrites the hypertext data so that a display portion of the warning message regarding a tentative inappropriate Website has links with a URI showing where the restriction hypertext data is stored (step S509). The control section 201 then proceeds to step S213.

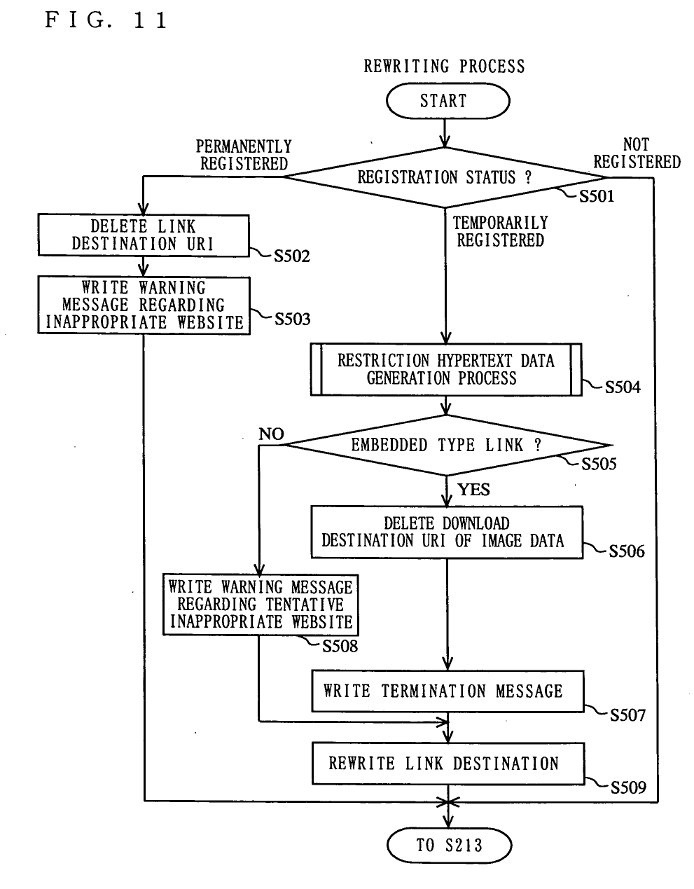

FIG. 12 is a flowchart showing an operation of the access control apparatus 200 during a registration change process (step S220). Hereinafter, with reference to FIG. 12, the operation of the access control apparatus 200 when an agreement notification or a disagreement notification is received from the terminal 100 will be described.

First, the control section 201 determines whether the received notification is an agreement notification or a disagreement notification (step S601). If the received notification is an agreement notification, the control section 201 increments the inappropriateness determination number of the URI by 1 (step S603), and proceeds to step S604. On the other hand, if the received notification is a disagreement notification, the control section 201 increments the appropriateness determination number of the URI by 1 (step S602), and proceeds to step S604.

In step S604, the control section 201 refers to the access management database for checking the inappropriateness determination number and the appropriateness determination number, and determines whether the sum of the inappropriateness determination number and the appropriateness determination number is equal to or greater than a predetermined number (for example, 10). If it is not equal to or greater than the predetermined number, the control section 201 ends the process.

On the other hand, if it is equal to or greater than the predetermined number, the control section 201 determines whether or not the inappropriateness determination number is equal to or greater than the appropriateness determination number (step S605). If the inappropriateness determination number is equal to or greater than the appropriateness determination number, the control section 201 changes the registration status of the URI to a permanent registration (step S607), and ends the process.

On the other hand, if the inappropriateness determination number is not equal to or greater than the appropriateness determination number, the control section 201 deletes the URI from the access management database (step S606), and ends the process. After deletion, the URI deleted from the access management database is treated as an appropriate URI.

As such, according to the embodiment of the present invention, the access management database temporarily registers a potentially inappropriate URI. If the user requests to access a Website of the temporarily registered URI, the access control apparatus 200 writes a warning message regarding a tentative inappropriate Website in the hypertext data, or terminates execution of the Web page of the URI, rather than transmits the regular hypertext data. Then, the access control apparatus 200 transmits unoffending image data and restriction hypertext data to the terminal 100, and causes the terminal 100 to display an unoffending image for allowing the user to determine whether or not the displayed image is inappropriate. As a result, the access control apparatus 200 of the present invention allows the user to individually determine whether or not a site temporarily registered as inappropriate is really inappropriate, rather than prohibiting a link with all sites temporarily registered as inappropriate. Thus, it is possible to provide a flexible access control apparatus. Also, the access control apparatus 200 checks a content of a link destination URI to be displayed on the Web page determined as appropriate.

Also, the access control apparatus 200 updates the access management database in accordance with the user's determination, whereby it is possible to customize a database to suit a corporate structure of a company for which the access restriction system 1 is established. As a result, it is possible to provide a highly reliable database.

Furthermore, such a customized database can be used as a useful access management database by a company in the same business. Thus, it is possible to sell the above-described customized database to people in the same business, which is an economic advantage.

Note that, in the above-described embodiment, the access control apparatus 200 and the terminal 100 are connected to each other via the LAN, but a network for connecting the access control apparatus 200 and the terminal 100 is not limited thereto. For example, the access control apparatus 200 and the terminal 100 may be connected to each other via a public network, etc., in the case where a provider has the access control apparatus 200.

Note that, in the above-described embodiment, the access management database is provided in the access restriction system 1, but it is not limited thereto. For example, the access control apparatus 200 may access an external server for referring to the access management database in the case where the access management database is provided in the external server.

Note that, in the above-described embodiment, the unoffending image generating section 202 generates unoffending image data by changing a color of an image, but it is not limited thereto. For example, the unoffending image generating section 202 may generate unoffending image data by performing a size change, such that a size of an image to be displayed on the Web page is reduced.

Also, the unoffending image generating section 202 may generate unoffending image data by the following operations: changing an aspect (length-to-width) ratio of the original image; dividing the original image like a jigsaw puzzle and arranging the divided images at random; or converting the original image as if it was viewed through a fish-eye lens or attached to a curved surface of a sphere.

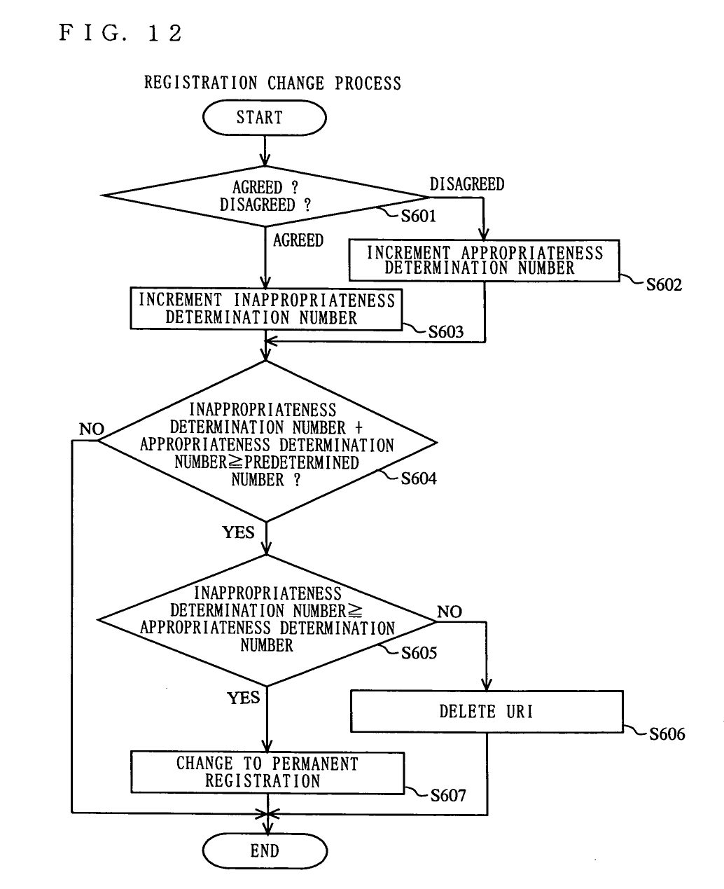

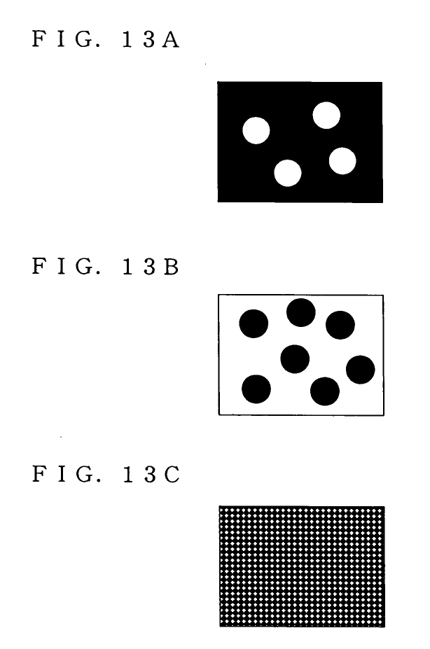

Also, the unoffending image generating section 202 may generate an unoffending image data by attaching a punched filter image (see FIG. 13A), a dotted filter image (see FIG. 13B), or a meshed filter image (see FIG. 13C) to the image to be displayed on the Web page. Note that an exemplary filter image is not limited to those shown in FIGS. 13A, 13B, and 13C. An image having a blacked-out portion may be used as a filter image.

Also, unoffending image data may be generated by obscuring the original image by a mosaic, or may be generated by lowering the image quality.

As such, an unoffending image needs to allow the user to roughly grasp the content of the potentially inappropriate Web page.

Note that a predetermined determination condition used for changing a tentative inappropriate URI to an inappropriate URI is not limited to the condition shown in FIG. 12. For example, a predetermined number used for comparison with the sum of the inappropriateness determination number and the appropriateness determination number may vary with each URI. For example, if a smaller predetermined number is set for a highly inappropriate URI, the access control apparatus 200 can promptly determine that the highly inappropriate URI is inappropriate. On the other hand, a greater predetermined number may be set for a URI whose inappropriateness is difficult to be determined, thereby leaving the determination to a majority vote of the users.

Also, initial values may be assigned to the inappropriateness determination number and the appropriateness determination number. For example, in the case of a highly inappropriate URI, a greater initial value may be assigned to the inappropriateness determination number. On the other hand, in the case of a less inappropriate URI, a greater initial value may be assigned to the appropriateness determination number. As a result, the access control apparatus 200 can promptly determine whether or not the URI is inappropriate. Also, if a network administrator sets an initial value, it is possible to reflect his/her intention in the determination of whether or not the URI is inappropriate.

Also, another point system may be introduced to register the number of points of inappropriateness/appropriateness determination by assigning a weight to each user, such that the inappropriateness/appropriateness determination number is incremented by two points when a person at the managerial level determines that the site is inappropriate/appropriate, and the inappropriateness/appropriateness determination number is incremented by one point when a rank-and-file employee determines that the site is inappropriate/appropriate. As a result, the degree of soundness of judgment of company members is reflected in the access management database. Note that a weight may be determined based on the degree of soundness of judgment of each company member, rather than based on the position in the company.

Also, in order to prevent the inappropriateness/appropriateness determination number from being frequently updated by the determination repeatedly transmitted by the same user, the access control apparatus may set an identification number for each user so that the determination made by one user is reflected in the access management database only once: As a result, it is possible to enhance reliability of the database.

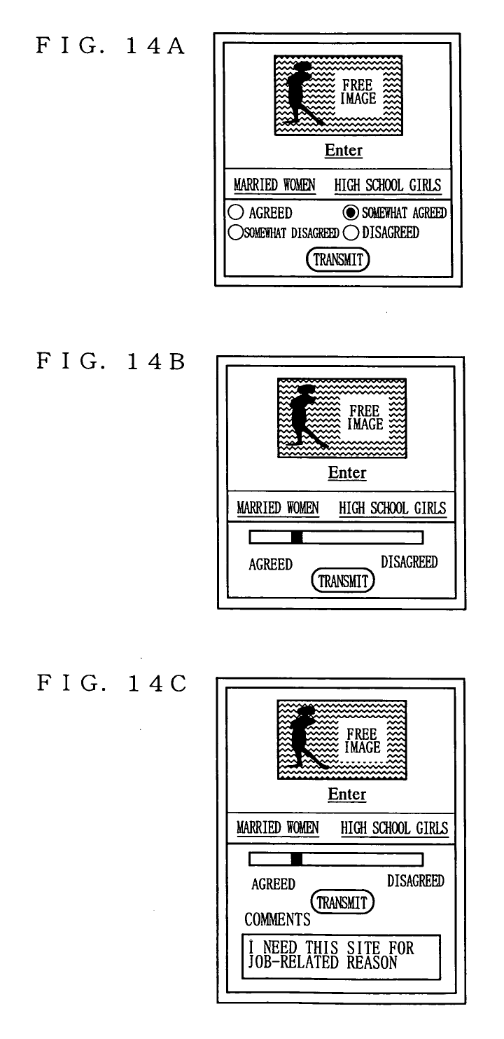

Also, the access control apparatus may allow the user to decide a subtle degree of inappropriateness/appropriateness of the site. FIGS. 14A to 14C are illustrations showing an exemplary subwindow for displaying an unoffending image in the case where the user is allowed to decide a subtle degree of inappropriateness/appropriateness of a site. Radio buttons showing texts such as “disagreed”, “somewhat disagreed”, “somewhat agreed”, and “agreed” may be provided as shown in FIG. 14A. Alternatively, a slide bar may be provided as shown in FIG. 14B. As a result, the user is allowed to decide a subtle degree of inappropriateness/appropriateness of the site.

Also, as shown in FIG. 14C, a space may be provided for allowing the user to enter his/her comments about the determination therein. In this case, the user's comments are registered in the access management database. When the unoffending image data of the same URI is generated, the access control apparatus 200 may transmit the above comments to the terminal 100 to display the comments in the subwindow. The above comments help other user to determine whether or not the site is inappropriate.

Note that, in the above-described embodiment, the access management database is automatically updated. Alternatively, the network administrator may update the access management database manually.

Note that a warning message regarding a tentative inappropriate Website is not limited to the message shown in the above-described embodiment. For example, a color, a character size, a font, a character style, an ornament font, and an identification mark, etc., used in the message may be changed, so long as the user can recognize that the site is potentially inappropriate.

Note that, in the above-described embodiment, after transmitting the site of the tentative inappropriate URI to the terminal 100, and causing the terminal 100 to display the site (that is, after step S219), the access control apparatus 200 may cause the user to recheck whether or not the site is really appropriate, and receive the checking results. In this case, the access control apparatus 200 may additionally write data for displaying the agreement and disagreement buttons in the original hypertext data obtained in step S218 in order to check the user's decision. Also, the access control apparatus 200 may utilize the checking results when updating the access management database. For example, the access control apparatus 200 may increment the inappropriateness/appropriateness determination number based on the checking results. Alternatively, for example, the inappropriateness/appropriateness determination number may be incremented by an increased point based on the checking results, or the checking results may be registered in the access management database separately from the inappropriateness/appropriateness determination number, in order to change a temporal registration from/to a permanent registration in accordance with the registered checking results.

Note that, in the above-described embodiment, the access control apparatus 200 may store an access history of the Website of the tentative inappropriate URI for issuing a warning, after the URI is determined as inappropriate, to the user who has accessed to the Website of the URI. In this case, a difference between the appropriateness determination number and the inappropriateness determination number is taken into consideration so that a warning is issued only if the inappropriateness determination number is apparently smaller than the appropriateness determination number. This warning may be issued manually by the network administrator.

Also, in the above-described embodiment, as shown in FIG. 10, the access control apparatus 200 generates restriction hypertext data after unoffending image data is generated (step S402). Here, the access control apparatus 200 may generate restriction hypertext data when actually transmitting the unoffending image data to the terminal 100. In this case, the process in steps S403 to S404 of FIG. 10 is performed immediately after step S215 of FIG. 8.

Also, in the above-described embodiment, the control section 201 of the access control apparatus 200 is a general-purpose CPU (not shown) reading the access control program from the storing section for execution. However, the control section 201 may be, for example, a dedicated LSI to which a program having the above-described functions are masked.

Also, data transmitted from the access control apparatus to the terminal may be described with any type of markup language, such as HTML (Hyper Text Markup Language), SGML (Standard GeneralizedMarkupLanguage), or XML (eXtensibleMarkupLanguage).

Also, in the above-described embodiment, the access control apparatus 200 generates rewritten hypertext data by performing a rewriting process for all link destination URIs described in the hypertext data. Here, the access control apparatus 200 may generate rewritten hypertext data every time it performs a rewriting process for one link destination URI (step S212), and transmit the generated hypertext data to the terminal 100. In this case, the access control apparatus 200 generates the hypertext data sets as many as the link destination URIs described in the hypertext data, and transmits the generated data to the terminal 100. Also, in this case, determination about whether or not all URIs are extracted (step S213) is performed after transmission of the rewritten hypertext data and the accompanying data (step S214). When all link destination URIs are extracted, the access control apparatus 200 ends the process. On the other hand, if all link destination URIs are not extracted, the access control apparatus 200 proceeds to a process in step S211.

As described above, the access control apparatus according to the present invention is effectively used as an access restriction apparatus, etc., for customizing the database of URIs, to which access restriction is to be applied, in accordance with an intended purpose of the user.

While the invention has been described in detail, the foregoing description is in all aspects illustrative and not restrictive. It is understood that numerous other modifications and variations can be devised without departing from the scope of the invention.

What is claimed is:

1. An access control apparatus for restricting access from at least one terminal on a network to a Website on the Internet, comprising:
source data obtaining means for obtaining source data necessary for displaying a Web page by accessing a Website corresponding to a URI when the URI is received from the terminal;
access restriction determination means for determining whether or not access to a Website corresponding to a link destination URI linked to the source data obtained by the source data obtaining means is restricted;
restriction source data obtaining/storing means for obtaining source data necessary for displaying a Web page from an access-restricted Website, and storing the obtained source data as restriction source data if determination is made by the access restriction determination means that access to the Website corresponding to the link destination URI is restricted;
image data obtaining means for obtaining image data designated in the restriction source data obtained by the restriction source data obtaining/storing means;
unoffending image generating means for generating unoffending image data by converting the image data obtained by the image data obtaining means;
rewritten source data generating/transmitting means for generating rewritten source data by rewriting the source data of the Website, for which determination is made by the access restriction determination means that access thereto is restricted, so as to obtain the restriction source data, and transmitting the rewritten source data to the terminal; and
unoffending image transmitting means for transmitting the restriction source data and the unoffending image data to the terminal if a link to the restriction source data is requested by the terminal.

2. The access control apparatus according to claim 1, wherein the rewritten source data generating/transmitting means generates rewritten source data describing access restriction to the Website for which determination is made by the access restriction determination means that access thereto is restricted.

3. The access control apparatus according to claim 1, wherein the rewritten source data generating/transmitting means generates rewritten source data describing a link destination URI corresponding to the Website for which determination is made by the access restriction determination means that access thereto is restricted.

4. The access control apparatus according to claim 1, further comprising prohibition determination means for determining whether or not access to the Website corresponding to the link destination URI is prohibited if determination is made by the access restriction determination means that access thereto is restricted, wherein
when determination is made by the prohibition determination means that access to the Website corresponding to the link destination URI is prohibited, the rewritten source data generating/transmitting means generates rewritten source data by rewriting a description of the source data to disable a link to the Website.

5. The access control apparatus according to claim 4, wherein the rewritten source data generating/transmitting means generates rewritten source data describing prohibition of access to the Website for which determination is made by the prohibition determination means that access thereto is prohibited.

6. The access control apparatus according to claim 1, wherein the URI of the restricted Website is registered in a database, the apparatus further comprising:
notification instruction describing means for describing an instruction, in the restriction source data, for causing the terminal to transmit an agreement determination notification indicating to what degree a user is able to agree with the determination that access is restricted;
agreement result registration means for registering a content of the agreement determination notification, which is received from the terminal, as being associated with the URI of the restricted Website; and
URI deleting means for deleting, from the database, a URI whose registration content registered by the agreement result registration means meets a predetermined condition.

7. The access control apparatus according to claim 6, wherein the predetermined condition is that agreement determination is performed more than a predetermined number of times, and a number of points added by users disagreeing with the determination is greater than a number of points added by users agreeing with the determination.

8. The access control apparatus according to claim 7, wherein the predetermine number of times is set for each URI.

9. The access control apparatus according to claim 7, wherein initial values are previously set as the number of points added by users disagreeing with the determination and/or the number of points added by users agreeing with the determination.

10. The access control apparatus according to claim 7, wherein the agreement result registration means assigns a weight to each user to change a number of points of agreement determination depending on the user.

11. The access control apparatus according to claim 1, wherein the URI of the restricted Website is registered in a database, the apparatus further comprising:
notification instruction describing means for describing an instruction, in the restriction source data, for causing the terminal to transmit an agreement determination notification indicating to what degree the user is able to agree with the determination that access is restricted;
agreement result registration means for registering a content of the agreement determination notification, which is received from the terminal, as being associated with the URI of the restricted Website; and
inappropriateness permanently-registration means for permanently registering a URI whose registration content registered by the agreement result registration means meets a predetermine condition in the database as a URI indicating an inappropriate Website.

12. The access control apparatus according to claim 11, wherein the predetermined condition is that agreement determination is performed more than a predetermined number of times, and a number of points added by users agreeing with the determination is greater than a number of points added by users disagreeing with the determination.

13. The access control apparatus according to claim 12, wherein the predetermined number is set for each URI.

14. The access control apparatus according to claim 12, wherein initial values are previously set as the number of points added by users disagreeing with the determination and/or the number of points added by users agreeing with the determination.

15. The access control apparatus according to claim 12, wherein the agreement result registration means assigns a weight to each user to change a number of points of agreement determination depending on the user.

16. The access control apparatus according to claim 1, further comprising:
disagreement notification instruction describing means for describing an instruction, in the restriction source data, for causing the terminal to transmit a disagreement notification indicating that the user disagrees with the determination that access is restricted; and
restriction cancel source data transmitting means for obtaining source data and image data necessary for displaying a Web page from the access-restricted Website, when the disagreement notification transmitted from the terminal is received, and transmitting the obtained data to the terminal.

17. The access control apparatus according to claim 1, further comprising:
notification URI regulation determination means for determining whether or not the Website corresponding to the URI received from the terminal is a tentative inappropriate Website; and
tentative inappropriateness notification source data generating/transmitting means for generating tentative inappropriateness notification source data describing a link to the restriction source data if determination is made by the notification URI regulation determination means that the Website corresponding to the URI is a tentative inappropriate Website, and transmitting the generated data to the terminal.

18. The access control apparatus according to claim 17, wherein the tentative inappropriateness notification source data generating/transmitting means generates tentative inappropriateness notification source data describing access restriction to the Website determined as a tentative inappropriate Website by the notification URI regulation determination means.

19. The access control apparatus according to claim 17, wherein the tentative inappropriateness notification source data generating/transmitting means generates tentative inappropriateness notification source data describing a link destination URI corresponding to the Website determined as a tentative inappropriate Website by the notification URI regulation determination means.

20. The access control apparatus according to claim 1, further comprising:
notification URI prohibition determination means for determining whether or not a Website corresponding to the URI received from the terminal is an inappropriate Website to which access prohibition is applied; and
inappropriateness notification source data generating/transmitting means for generating inappropriateness notification source data describing access prohibition to the Website corresponding to the URI if determination is made by the notification URI prohibition determination means that the Website corresponding to the URI is an inappropriate Website, and transmitting the generated data to the terminal.

21. The access control apparatus according to claim 1, wherein the unoffending image generating means generates unoffending image data by converting the image data so that at least a portion thereof is hidden from view.

22. The access control apparatus according to claim 1, wherein the unoffending image generating means generates unoffending image data by changing a color of an image on the Web page.

23. The access control apparatus according to claim 1, wherein the unoffending image generating means generates unoffending image data by changing a size of an image on the Web page.

24. The access control apparatus according to claim 1, wherein the unoffending image generating means generates unoffending image data by changing an aspect ratio of an image on the Web page.

25. The access control apparatus according to claim 1, wherein the unoffending image generating means generates unoffending image data by dividing an image on the Web page into a plurality of parts, and arranging the divided parts at random.

26. The access control apparatus according to claim 1, wherein the unoffending image generating means generates unoffending image data by converting an image on the Web page as if it was attached to a curved surface.

27. The access control apparatus according to claim 1, wherein the unoffending image generating means generates an unoffending image by attaching a filter image having a blacked-out portion to an image on the Web page.
